(19) United States
(12) Patent Application Publication
(10) Pub. No.: US 2016/0069113 A1
(43) Pub. Date: Mar. 10, 2016

(54) MESH BARRIER ASSEMBLY

(71) Applicant: MUNCHKIN, INC., Van Nuys, CA (US)

(72) Inventors: Thomas E. BIRKERT, West Hills, CA (US); Sung Yun CHAN, Pasadena, CA (US); Ruth Hsin-Ju FANG, Monterey Park, CA (US); Nicholas TRUMBO, La Canada, CA (US)

(21) Appl. No.: 14/818,017

(22) Filed: Aug. 4, 2015

Related U.S. Application Data
(60) Provisional application No. 62/046,851, filed on Sep. 5, 2014.

(51) Int. Cl. E05D 7/12; E06B 11/04

(52) U.S. Cl. CPC E05D 7/12; E06B 11/04; E06B 2009/002

(57) ABSTRACT

A pressure fit mesh gate having a outer casing and a mesh barrier door. The outer casing has a pair of upright frame elements connected to a lower cross element. The mesh barrier door is positioned within the outer casing. The mesh barrier door is hingedly connected to one of the upright frame elements. The barrier door has a frame including a first side member and a second side member friction fit connected at their ends by corner joints to an upper member and a lower member. At least one of the corner joints is a two-part corner joint. The two-part corner joint has a first extension that is friction fit into a first end of one of the members, and a second extension friction fit into an adjacent end of another one of the members. The first extension has a first friction fit element in a first base that is secured to a second friction fit element on the second extension in a second base.

### CROSS REFERENCE TO RELATED APPLICATION

This application incorporates and claims the benefit of the filing date of U.S. Provisional Patent Application Ser. No. 62/046,851, entitled “MESH BARRIER ASSEMBLY” filed Sep. 5, 2014, the entirety of which is incorporated herein by reference.

### TECHNICAL FIELD

The subject disclosure relates to barrier devices. More particularly, the present disclosure relates to a mesh panel barrier.

### BACKGROUND

Falls are a leading cause of injuries to children and toddlers in the home. Safety gates can be used around the home to prevent children from entry into a staircase region or keep the children in a safe area in the home where they can be watched by a caregiver. Additionally, safety gates can be used to prevent movement of small household pets into unwanted spaces or rooms. However, traditional safety gates, such as mesh barrier type gates are often times difficult to transport and assemble, making it unduly cumbersome to try to move the gate to another location. Previous attempts at solving these deficiencies often resulted in gates with decreased structural stability.

### BRIEF DESCRIPTION OF THE DRAWINGS

Various exemplary embodiments of this disclosure will be described in detail, wherein like reference numerals refer to identical or similar components or steps, with reference to the following figures, wherein:

FIG. 1 illustrates an exemplary mesh barrier assembly in accordance with aspects described herein.

FIG. 2 depicts a front view of the mesh barrier assembly having a barrier with an integrated mesh panel.

FIG. 3 shows a front view of the mesh panel.

FIG. 4 illustrates a first step of assembling the barrier by inserting a first rod into a first fold of the mesh panel.

FIG. 5 depicts a detail view of the first step from FIG. 4.

FIG. 6 shows a second step of assembling the barrier by attaching a lower frame member to the mesh panel and rod combination.

FIG. 7 illustrates a side view of the lower frame member when attached to the mesh panel and rod combination.

FIG. 8 depicts a detailed view of the second step from FIG. 6.

FIG. 9 shows a third step of assembling the barrier by inserting a first corner member into the lower frame member.

FIG. 10 illustrates a detailed view of the third step from FIG. 9.

FIG. 11 depicts a fourth step of assembling the barrier by inserting a second rod into a second fold of the mesh panel.

FIG. 12 shows a fifth step of assembling the barrier by attaching a first side frame member to the mesh panel and rod combination.

FIG. 13 illustrates a sixth step of assembling the barrier by inserting a second corner member into the first side frame member.

FIG. 14 depicts a seventh step of assembling the barrier by inserting a third rod into a third fold of the mesh panel.

FIG. 15 shows an eighth step of assembling the barrier by attaching an upper frame member to the mesh panel and rod combination.

FIG. 16 illustrates a ninth step of assembling the barrier by inserting a third corner member into the upper frame member.

FIG. 17 depicts a tenth step of assembling the barrier by inserting a fourth rod into a fourth fold of the mesh panel.

FIG. 18 shows an eleventh step of assembling the barrier by attaching a second side frame member to the mesh panel and rod combination.

FIG. 19 illustrates a first exemplary embodiment of a twelfth step of assembling the barrier by inserting a corner track into the second side frame member.

FIG. 20 depicts a first exemplary embodiment of a thirteenth step of assembling the barrier by inserting a fourth corner member into the lower frame member along the corner track.

FIG. 21 shows a first exemplary embodiment of a fourteenth and final step of assembling the barrier by inserting a fastener through the fourth corner member and corner track.

FIG. 22 illustrates a second exemplary embodiment of the twelfth step of assembling the barrier by inserting a fourth corner member into the lower frame member.

FIG. 23 depicts a second exemplary embodiment of the thirteenth step of assembling the barrier by inserting a corner stopper through a shaft in the fourth corner member and into the second side frame member.

FIG. 24 shows a front view of the assembled barrier as constructed after the thirteenth step of FIG. 23.

FIG. 25 illustrates a perspective view of a second exemplary embodiment of the fourteenth step of assembling the barrier by inserting a fastener into the fourth corner member and the corner stopper.

### DETAILED DESCRIPTION

Particular embodiments of the present invention will now be described in greater detail with reference to the figures.

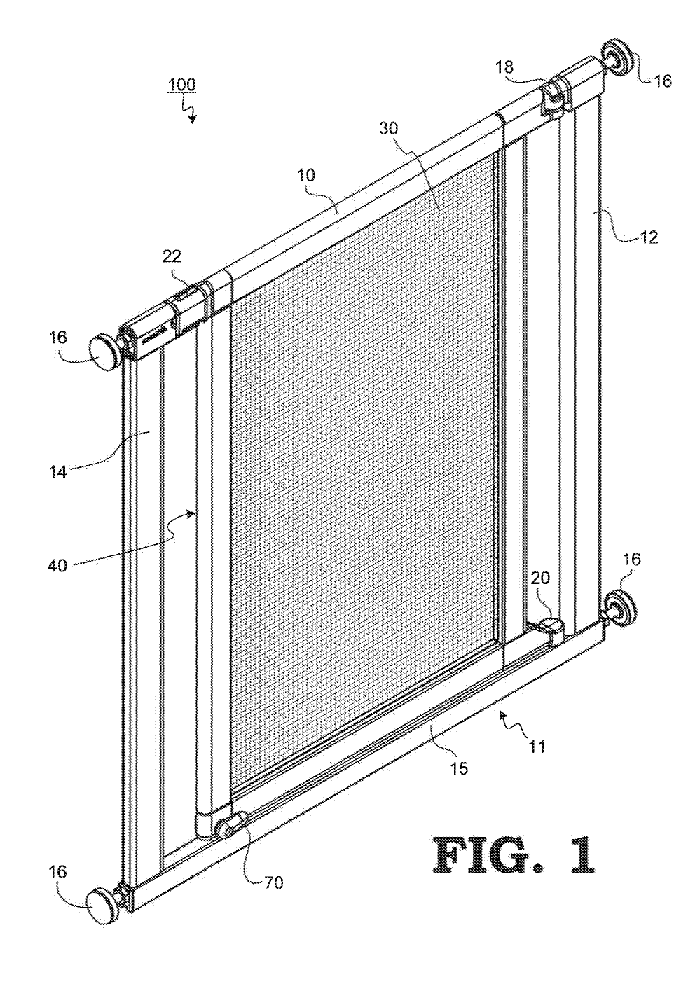

FIG. 1 illustrates an exemplary mesh barrier assembly 100 in accordance with aspects described herein. The mesh barrier assembly has a barrier or barrier door 10 hingedly attached to an outer casing or support structure 11 by an upper hinge 18 and a lower hinge 20. The barrier 10 includes a mesh panel 30 and a barrier door or mesh panel frame 40. The support structure 11 includes a first upright frame element or vertical support structure 12, a second upright frame element or vertical support structure 14, a lower cross element or horizontal support structure 15, a plurality of adjustable fasteners 16, a barrier latch 22 and a stopper 70.

The mesh barrier assembly 100 may be installed between two walls, a door frame, etc. by positioning the mesh barrier assembly 100 such that the plurality of adjustable fasteners 16 rest abuttingly against the walls or door frames. The plurality of adjustable fasteners 16 may then be tightened or loosened to create a friction fit such that the fasteners 16 do not move relative to the walls or door frame when the mesh barrier assembly 100 is in use.

Generally, the barrier 10 may be opened by releasing the barrier latch 22 and pivoting the barrier 10 about the upper and lower hinges 18, 20. The stopper 70 may prevent the barrier 10 from opening outwards, inwards, or both while in a locked position.

The mesh panel 30 may be constructed out of any flexible or rigid mesh materials, or may alternatively be made of a fabric or suitable material. The mesh panel 30 may have any suitable size, shape or configuration to provide a barrier preventing children, infants or animals from crossing though the barrier. The mesh panel 30 may be a single construction, or may alternatively have a first material extending from a center of the mesh panel 30 and a second material proximate to the edges of the mesh panel 30, or any combination of materials.

The mesh panel 30 may also include different designs on one or both faces. These designs may be formed by apertures in the mesh, different materials which compose the mesh panel 30, different mesh densities used throughout the mesh panel 30, and materials permanently or removably attached to the face of the mesh panel 30, or any other suitable method by which to add the design to the mesh panel 30.

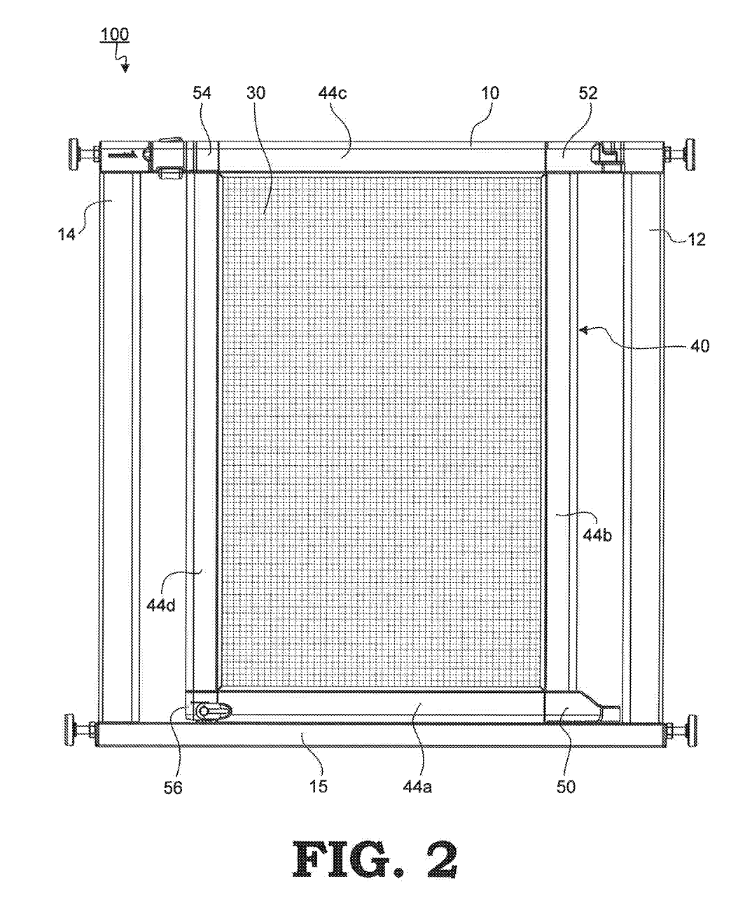

FIG. 2 depicts a front view of the mesh barrier assembly 100 having the barrier 10 with the integrated mesh panel 30 and mesh panel frame 40 or barrier door frame. The mesh panel frame 40 includes a lower frame member 44a, a first side frame member 44b, an upper frame member 44c, a second side frame member 44d, a first corner joint or first corner member 50, a second corner member 52, a third corner member 54 and a fourth corner member 56 which receive and secure the mesh panel 30 into the barrier 10.

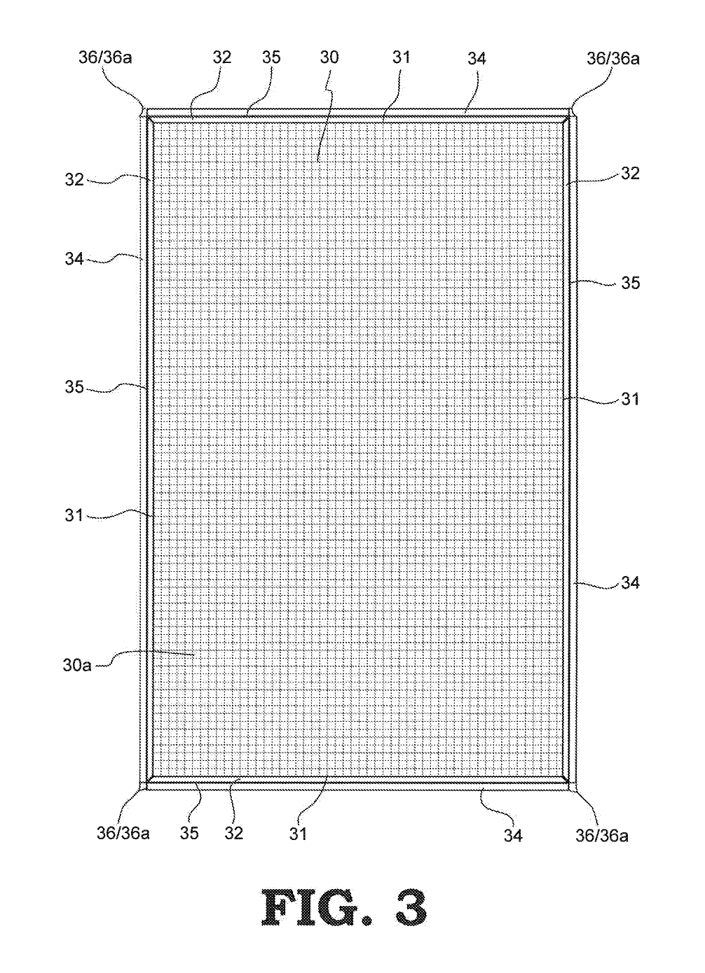

FIG. 3 shows a front view of the mesh panel 30. The mesh panel 30 includes four edges 31 which may be folded towards a center of the mesh panel 30 to form folds 34. The edges 31 are then attached to an inner face 30a of the mesh panel 30 at a sealing location 32 by heat sealing, metal fixtures, sewing, knotting, or any other suitable method for attaching the edges 31 to the inner face 30a. Each fold 34 forms a substantially cylindrical pocket 36 having openings 36a on corners of the mesh panel 30 as shown. Each of the pockets 36 is sealed along its length at an inner location 35 where the mesh panel 30 is two layers thick and sealed by one of the previously mentioned methods.

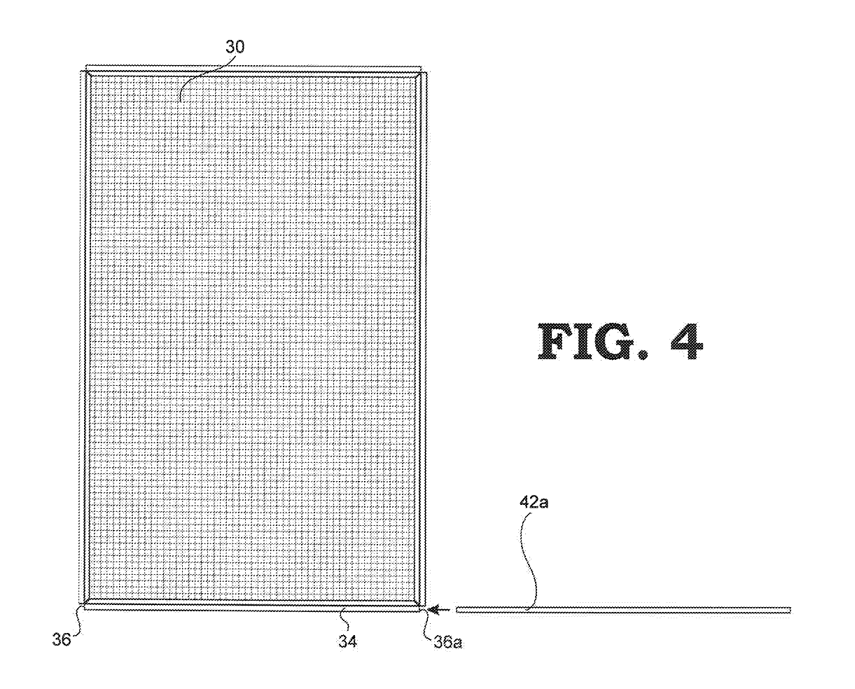

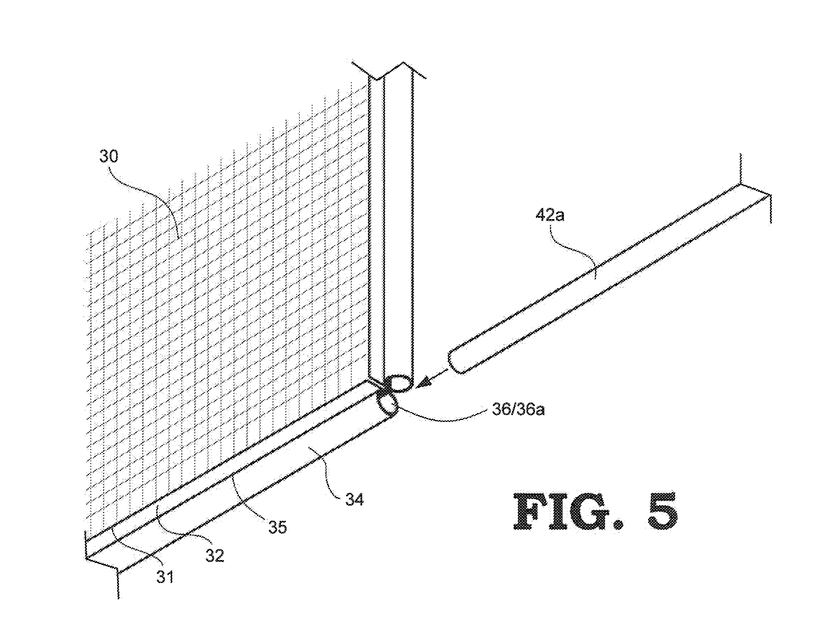

FIGS. 4-5 illustrate a first step of assembling the barrier 10 by inserting a first rod 42a into a first fold 34 of the mesh panel 30. The first rod 42a has an outer diameter barely smaller than the inner diameter of the pocket 36 and opening 36a. As such, the opening 36a receives a first end the first rod 42a. As the first rod 42a is inserted into the pocket 36, the mesh panel 30 will remain two layers of mesh thick at the inner location 35. When the first rod 42a is completely inserted into the pocket 36, the length of pocket 36 and the length of the first rod 42a may be coincident to one another. Whereas before the first rod 42a is inserted into the pocket 36, the first fold 34 which forms the pocket 36 will be flexible; however, after the first rod 42a is inserted the first fold 34 will grip the first rod 42a and may be substantially cylindrical encompassing an outer surface of the first rod 42a.

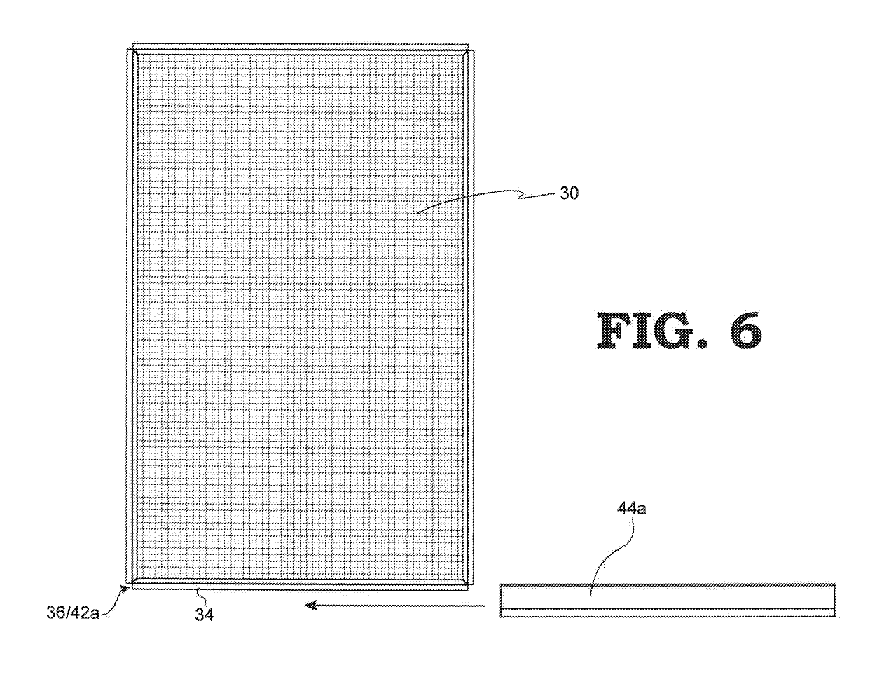

FIGS. 6-8 show a second step of assembling the barrier 10 by attaching a lower frame member 44a to the mesh panel 30 and rod 42a combination. As shown in FIG. 6, the lower frame member 44a secures and receives the first fold 34 which in stiffened by the first rod 42a. The lower frame member 44a slides over the combination of the fold 34 and first rod 42a until a length of the lower frame member 44a is substantially congruent to the length of the first rod 42a.

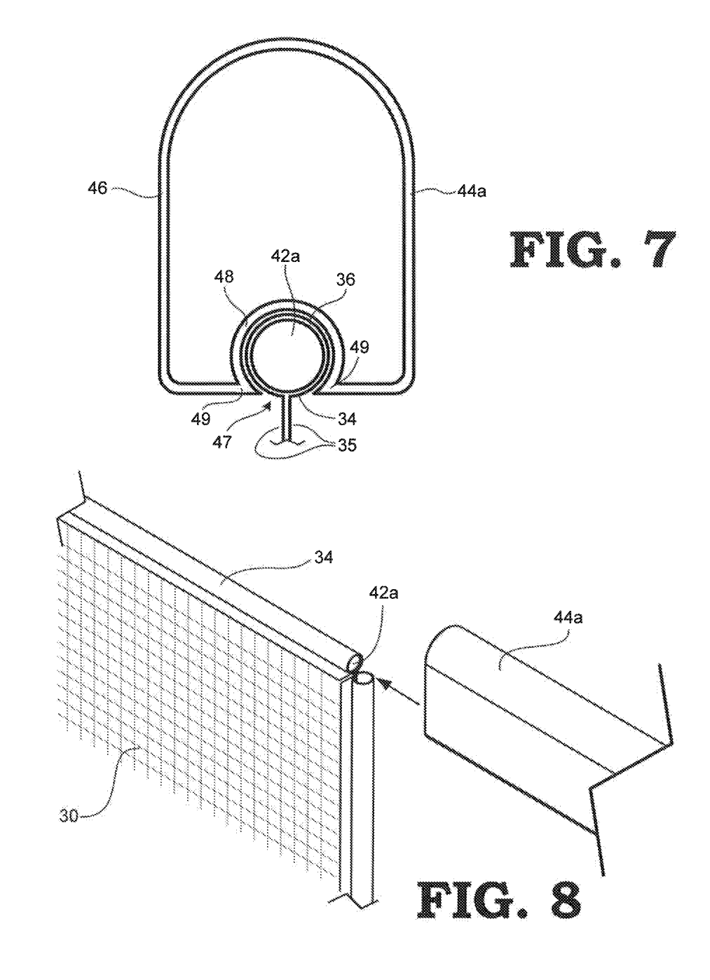

FIG. 7 depicts a detailed view of the lower frame member 44a after receiving the fold 34 and first rod 42a combination. As shown, the lower frame member 44a (as well as a first side frame member 44b, an upper frame member 44c and a second side frame member 44d) includes a frame member body 46 and a round track 48 with overhang portions 49. The round track 48 is substantially coincident to both the fold 34 and the first rod 42a when the barrier 10 is assembled. The overhang portions 49 prevent the first rod 42a from sliding out through an opening 47 of the round track 48. This configuration traps the mesh panel 30 between the first rod 42a and the lower frame member 44a. Such a configuration may be embodied as a tongue and groove mating system, a projection and channel mating system and/or any other suitable mating connection according to this subject disclosure. As shown in FIG. 8, when the lower frame member 44a is being installed, the sealed portion 35 of the mesh panel 30 slides within the opening 47.

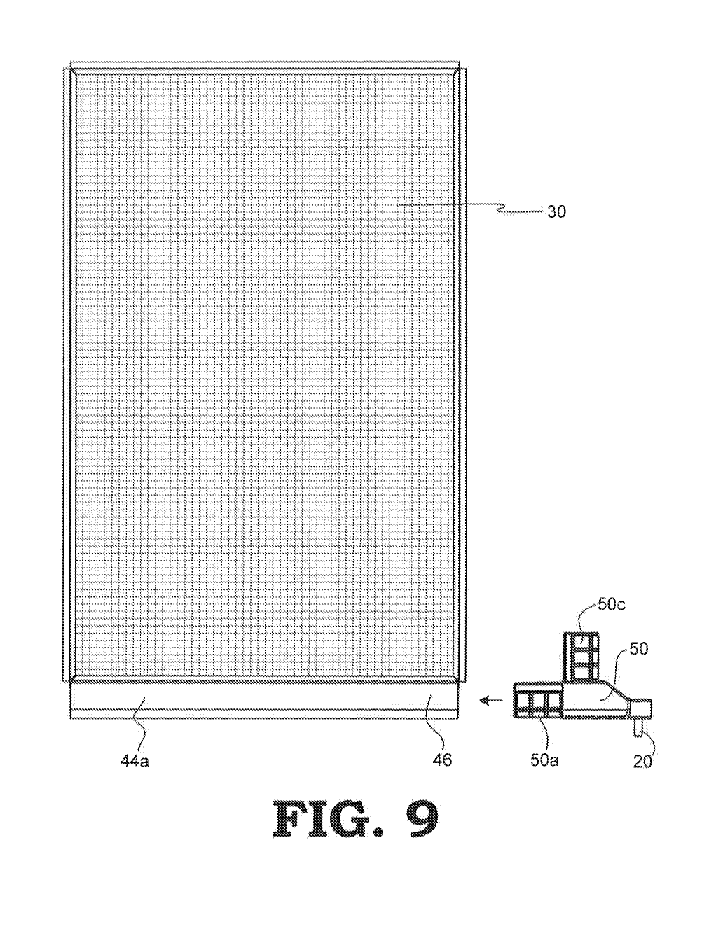

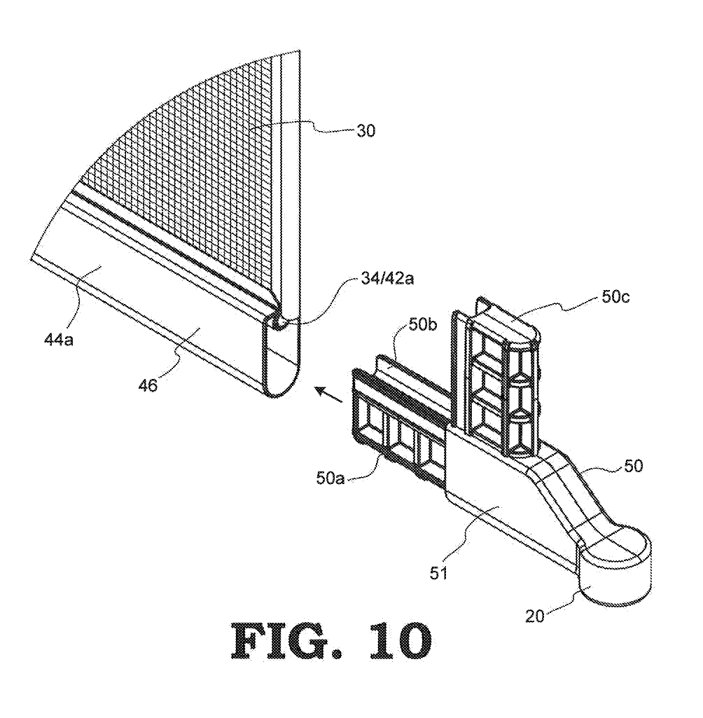

FIGS. 9-10 show a third step of assembling the barrier 10 by inserting a first corner joint or member 50 into the lower frame member 44a. The first corner member 50 includes a first friction fit stopper, an arm, or an extension 50a, a second friction fit stopper 50c and the lower hinge 20. As the first corner member 50 is being installed, the first friction fit stopper 50a is secured and received by the frame member body 46 of the lower frame member 44a.

As shown in greater detail in FIG. 10, an outer surface 50b of the first friction fit stopper 50a has a substantially similar shape to the inner surface of the lower frame member 44a. When the first corner member 50 is completely installed, the first friction fit stopper 50a may be completely held by a friction fit with the lower frame member 44a. The frame member body 46 may also be flush with an exposed portion 51 of the first corner member 50.

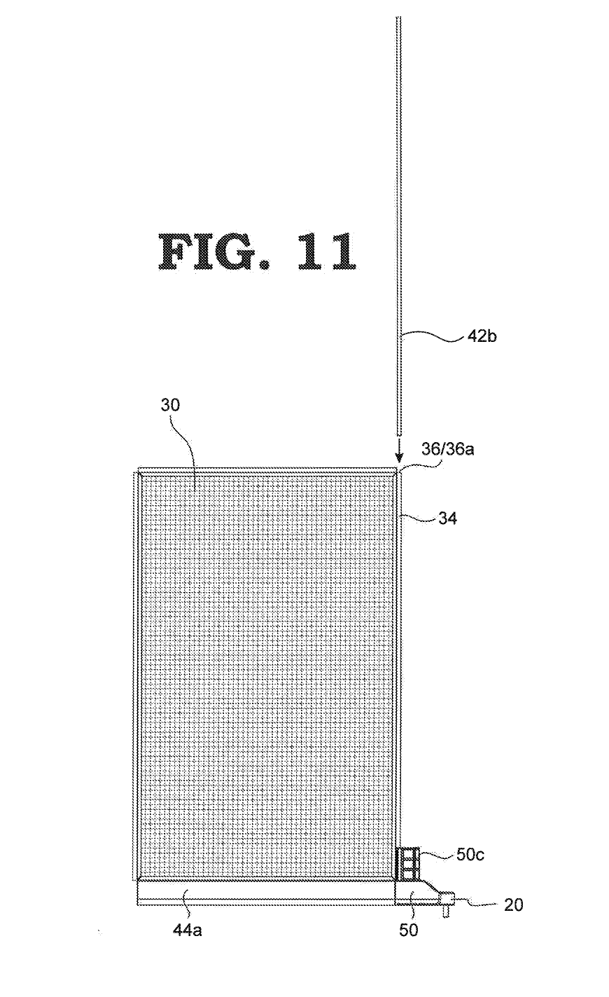

FIG. 11 depicts a fourth step of assembling the barrier 10 by inserting a second rod 42b into a second fold 36 of the mesh panel 30. Similar to the first step as shown and described in FIGS. 4-5, the second rod 42b slides into the pocket 36 formed by the fold 34 until a length of the second rod 42b is substantially congruent to a length of the pocket 36.

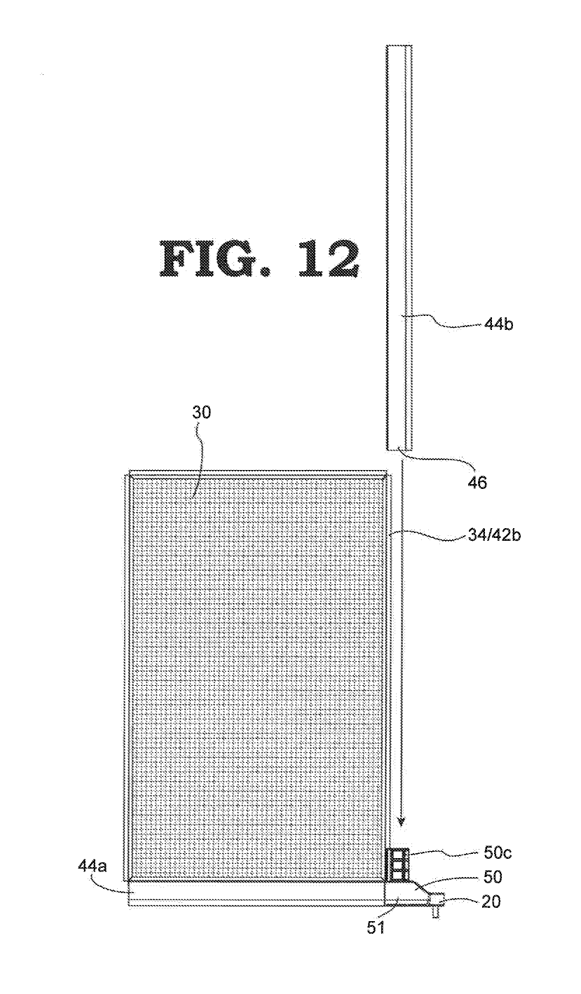

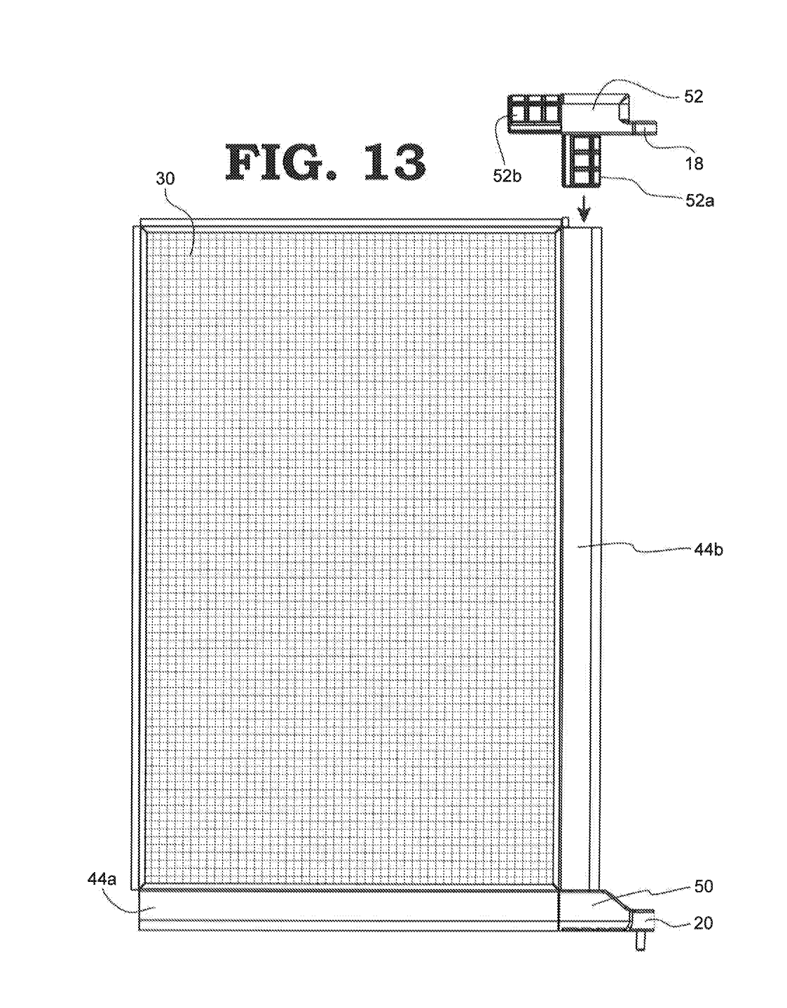

FIG. 12 shows a fifth step of assembling the barrier 10 by attaching a first side frame member 44b to the mesh panel 30 and second rod 42b combination. Similar to the second step as shown and described in FIGS. 6-8, the first side frame member 44b slidingly receives and secures the fold 34 and second rod 42b. Then, the first side frame member 44b receives and secures the second friction fit stopper 50c of the first corner member 50. Similarly, the first side frame member 44b may be substantially flush with the exposed portion 51 of the first corner member 50.

FIG. 13 illustrates a sixth step of assembling the barrier 10 by inserting a second corner member 52 into the first side frame member 44b. The second corner member 52 includes a first friction fit stopper 52a, a second friction fit stopper 52b and the upper hinge 18. The first friction fit stopper 52a is secured and received by the first side frame member 44b, as similarly shown and described in the third step in FIGS. 9-10.

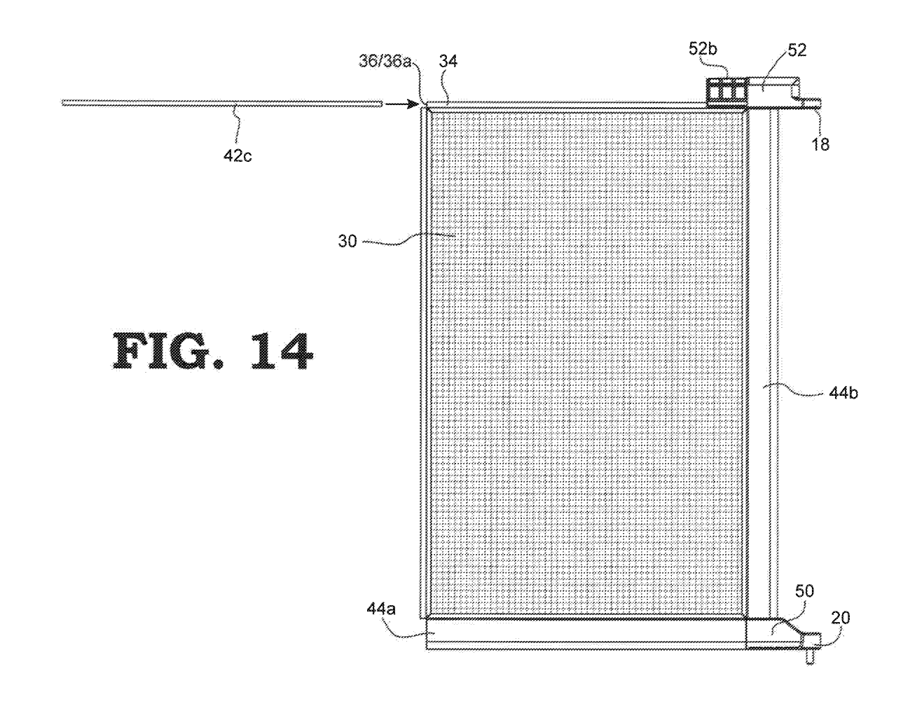

FIG. 14 depicts a seventh step of assembling the barrier 10 by inserting a third rod 42c into a third fold 34 of the mesh panel 30. Similar to the first step as shown and described in FIGS. 4-5, the third rod 42c slides into the pocket 36 formed by the fold 34 until a length of the third rod 42c is substantially congruent to a length of the pocket 36.

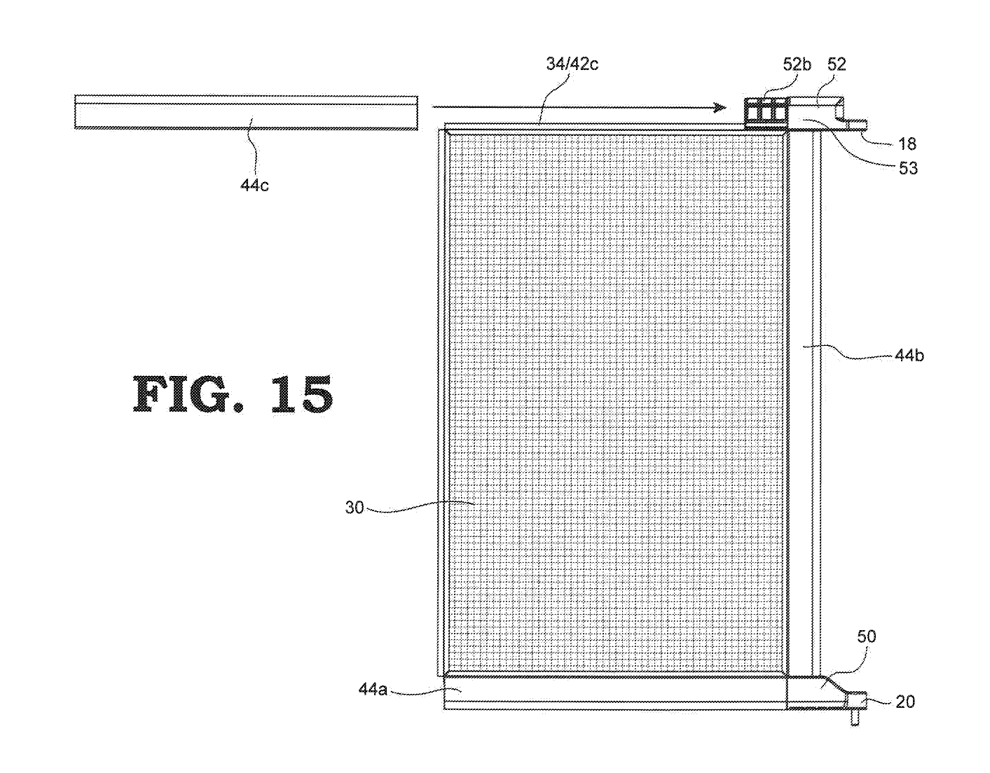

FIG. 15 shows an eighth step of assembling the barrier 10 by attaching an upper frame member 44c to the mesh panel 30 and rod 42c combination. Similar to the second step as shown and described in FIGS. 6-8, the upper frame member 44c slidingly receives and secures the fold 34 and third rod 42c. Then, the upper frame member 44c receives and secures the second friction fit stopper 52b of the second corner member 52. Similarly, the upper frame member 44c may be substantially flush with the exposed portion 53 of the second corner member 52.

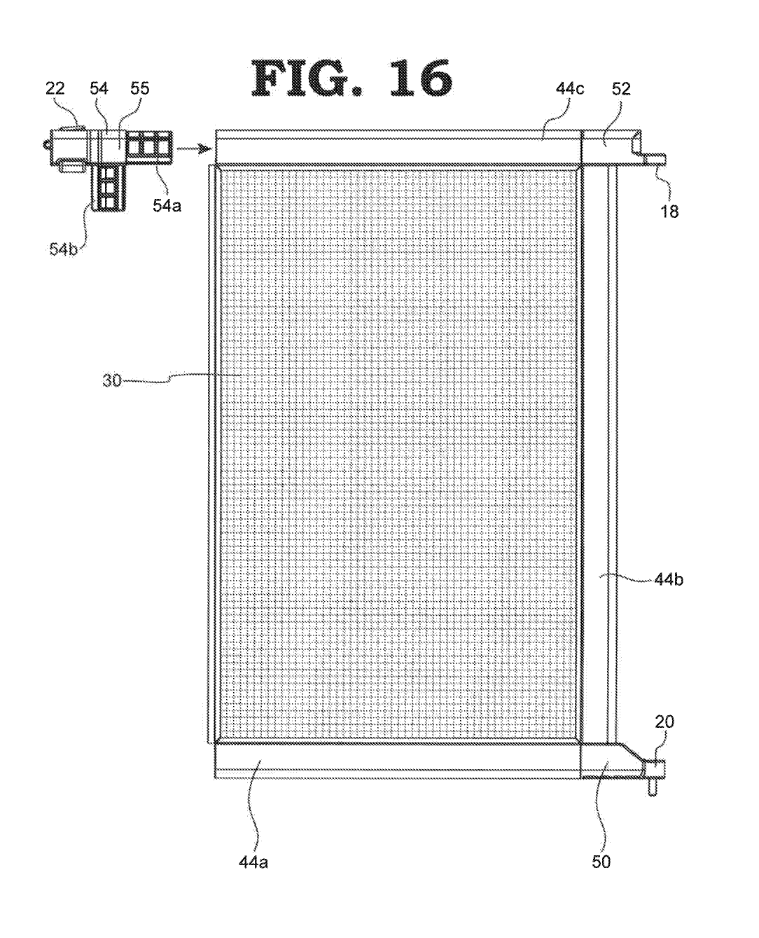

FIG. 16 illustrates a ninth step of assembling the barrier 10 by inserting a third corner member 54 into the upper frame member 44c. The third corner member 54 includes a first friction fit stopper 54a, a second friction fit stopper 54b and the latch 22. The first friction fit stopper 54a is secured and received by the upper frame member 44c, as similarly shown and described in the third step in FIGS. 9-10.

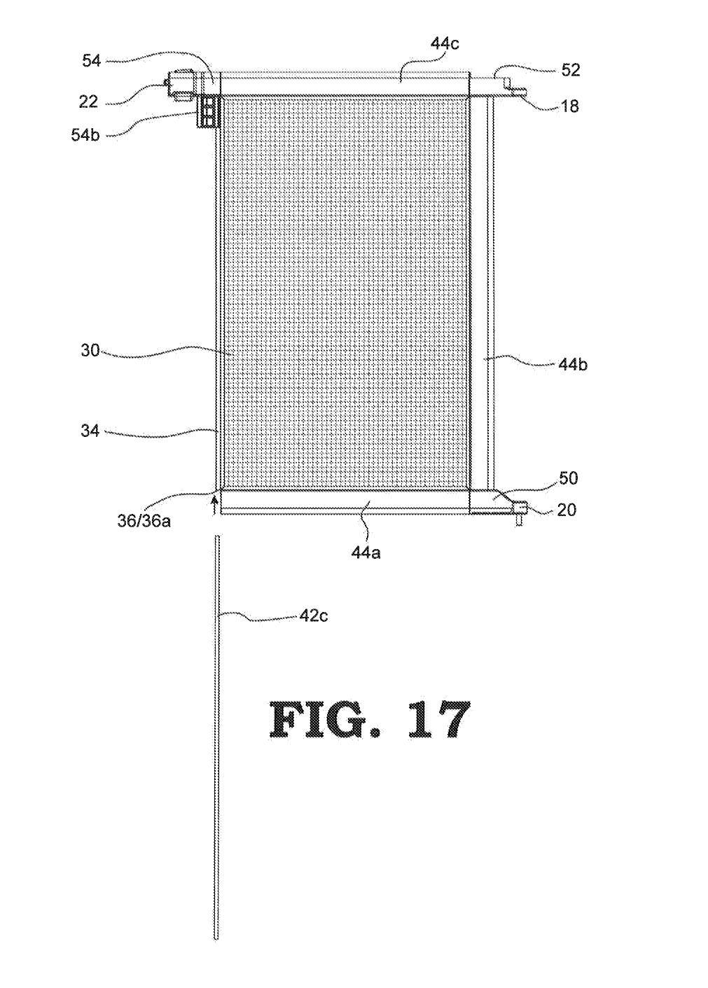

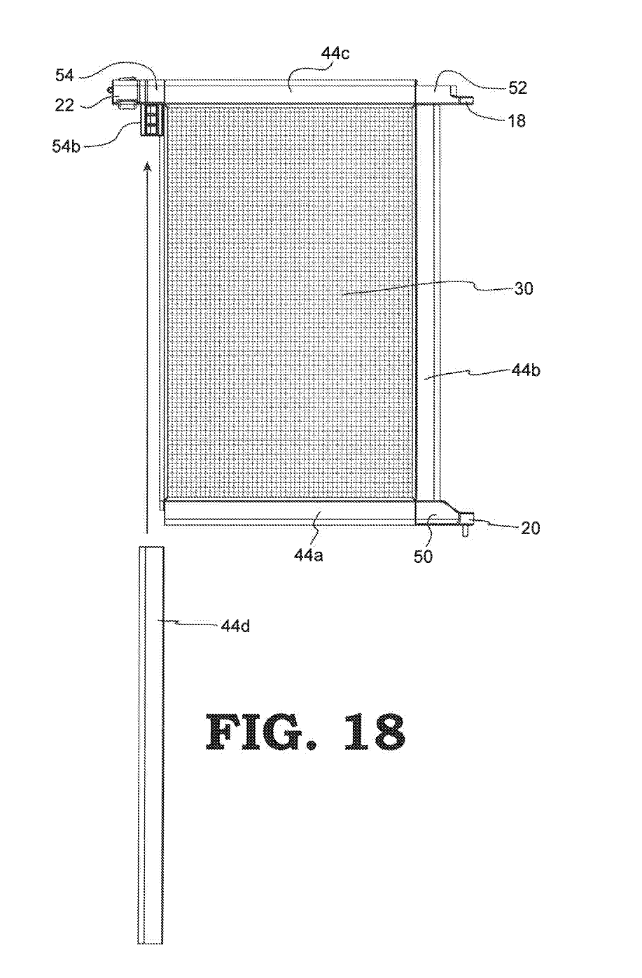

FIG. 17 depicts a tenth step of assembling the barrier 10 by inserting a fourth rod 44d into a fourth fold 34 of the mesh panel 30. Similar to the first step as shown and described in FIGS. 4-5, the fourth rod 42d slides into the pocket 36 formed by the fold 34 until a length of the third rod 42d is substantially congruent to a length of the pocket 36.

FIG. 18 shows an eleventh step of assembling the barrier 10 by attaching a second side frame member 44d to the mesh panel 30 and rod 42d combination. Similar to the second step as shown and described in FIGS. 6-8, the second side frame member 44d slidingly receives and secures the fold 34 and fourth rod 42d. Then, the second side frame member 44d receives and secures the second friction fit stopper 54b of the third corner member 54. Similarly, the second side frame member 44d may be substantially flush with the exposed portion 55 of the third corner member 54.

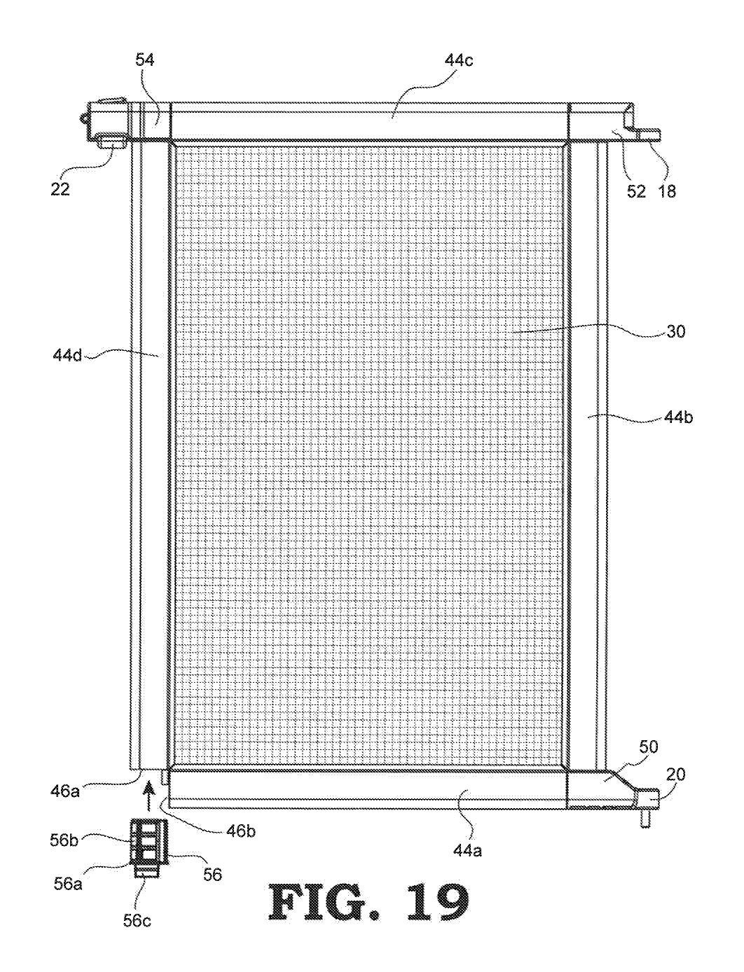

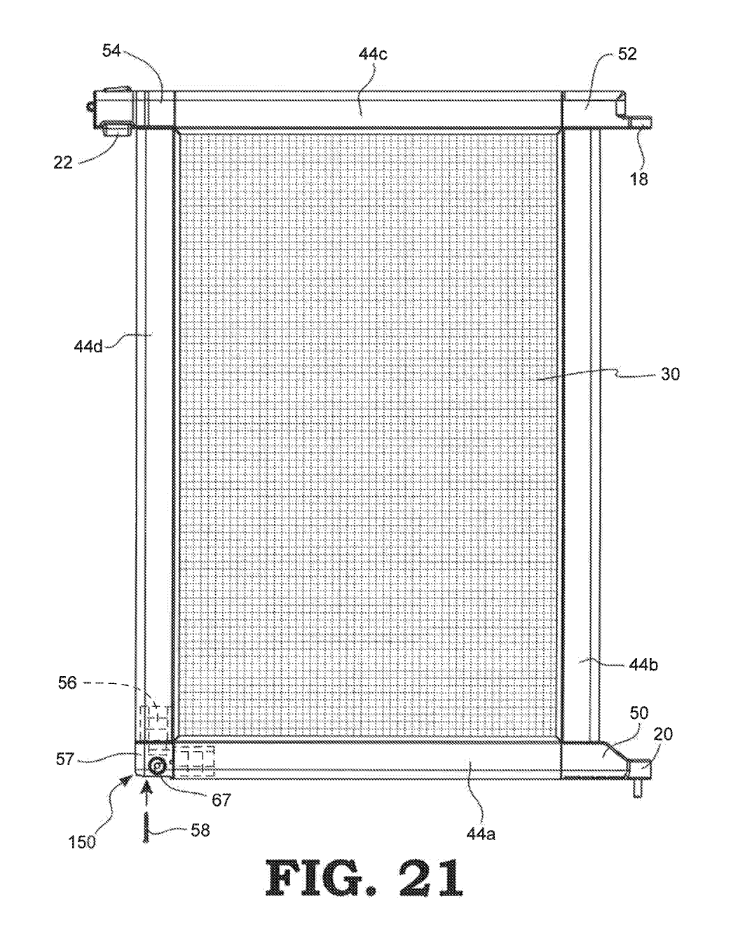

FIGS. 19-21 illustrate a first exemplary embodiment of installing a fourth and final two-piece corner joint 150 (as illustrated in FIG. 21). The corner joint 150 is embodied as a two-part assembly having a first part 56 having a first base 56a and a first arm or extension 56b, and a second part 57 having a second base 57a and a second arm or extension 57b. The first part 56 being connected to the second part 57 during assembly.

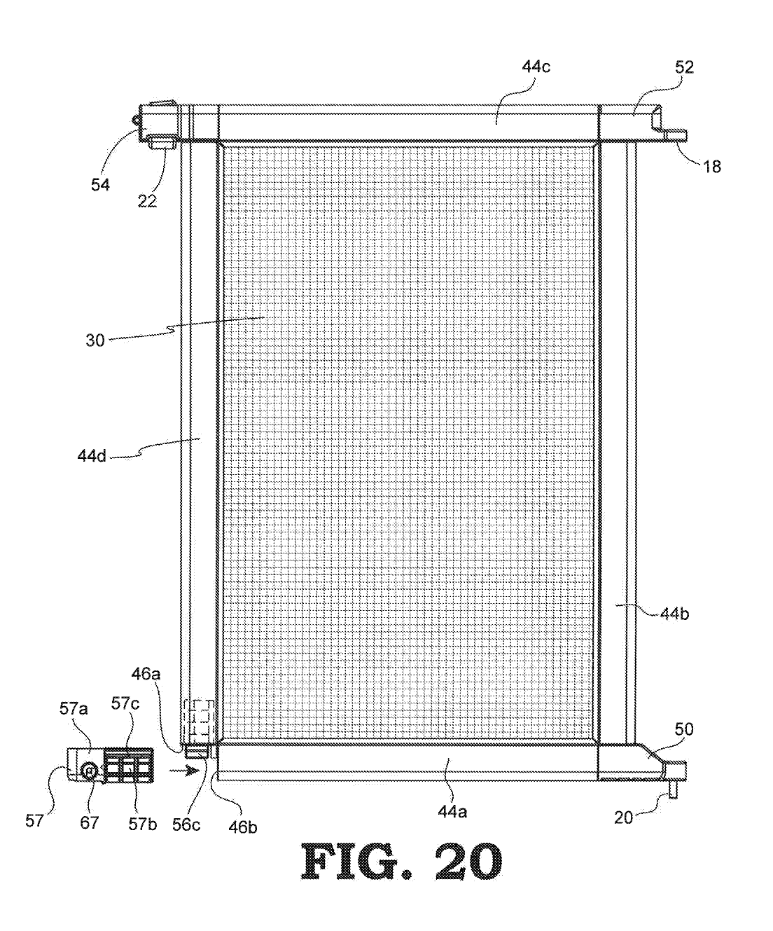

FIG. 19 illustrates a first exemplary embodiment of a twelfth step of assembling the barrier 10 by inserting a first arm 56b contoured to fit into a first end 46a of frame member body of the second side frame member 44d much like in the prior examples discussed above. The first part 56 of the two-piece corner joint 150 includes an elongated projection or fitting 56c extending opposite of the first arm 56b. The first arm or extension 56b is secured and received within an end 46a in the frame member body of the second side frame member 44d by a friction fit. As shown in position in FIG. 20, the elongated projection or fitting 56c extends transverse or substantially perpendicular to an axial length of the second side frame member 44d. The elongated projection or fitting 56c extends out from the end 46a of the frame member body a predetermined distance and is adapted to receive a mating portion constructed on the second part 57 of the two-piece corner joint 150.

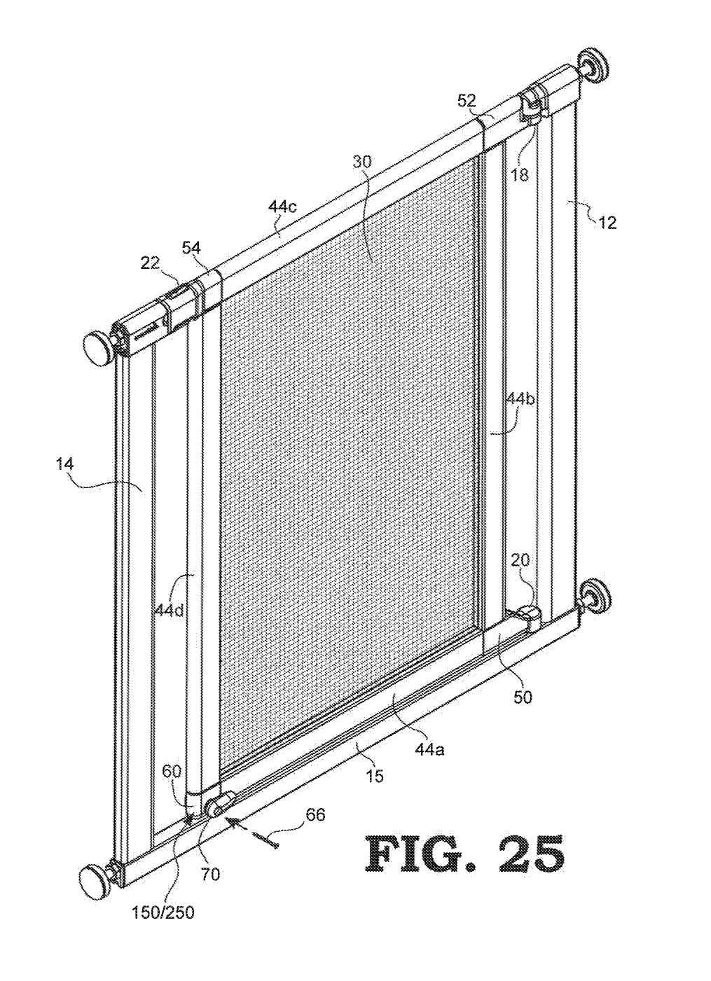

FIG. 20 depicts a thirteenth step of assembling the barrier 10 by inserting the second part 57 of the two-piece fourth corner joint 150 or member into an adjacent end 46b of the lower frame member 44a. The arm or extension 57b of the second part 57 of the corner joint 150 or member is secured and received within an adjacent end 46b disposed in the lower frame member 44a by a friction fit as discussed above in the prior examples. The second part 57 includes an elongated track 57c which includes overhang portions (similar to overhang portions 47) which secure and simultaneously receive the elongated projection or fitting 56c of the first part 56 as the elongated track 57c on the second part 57 is inserted into the adjacent end 46b of the lower frame member 44a. The second part 57 also includes an aperture 67 adapted to receive a stopper 70 (as shown in FIG. 25) to allow or disallow the barrier door 30 to open and close in a predetermined direction. It is to be understood that the mating connection securing the two-piece corner joint 150 together composed of the first part 56 and the second part 57 may be made in a variety of different ways, such as with a projection and channel combination, a tongue and groove connection, a fastener and/or any other suitable friction fit and/or mating connection between the first part 56 and the second part 57 of the two-piece corner 150 or joint member.

FIG. 21 shows a fourteenth and final step of assembling the barrier 10 by inserting a fastener 58 into and through the second part 57 and into the first part 56 of the fourth corner joint member 150 in order to secure the two parts 56, 57 together. The fastener 58 may be a screw, bolt and nut, magnet, clamp, rivet, or any other suitable fastener to secure the first part 56 to the second part 57 of the fourth corner joint member 150.

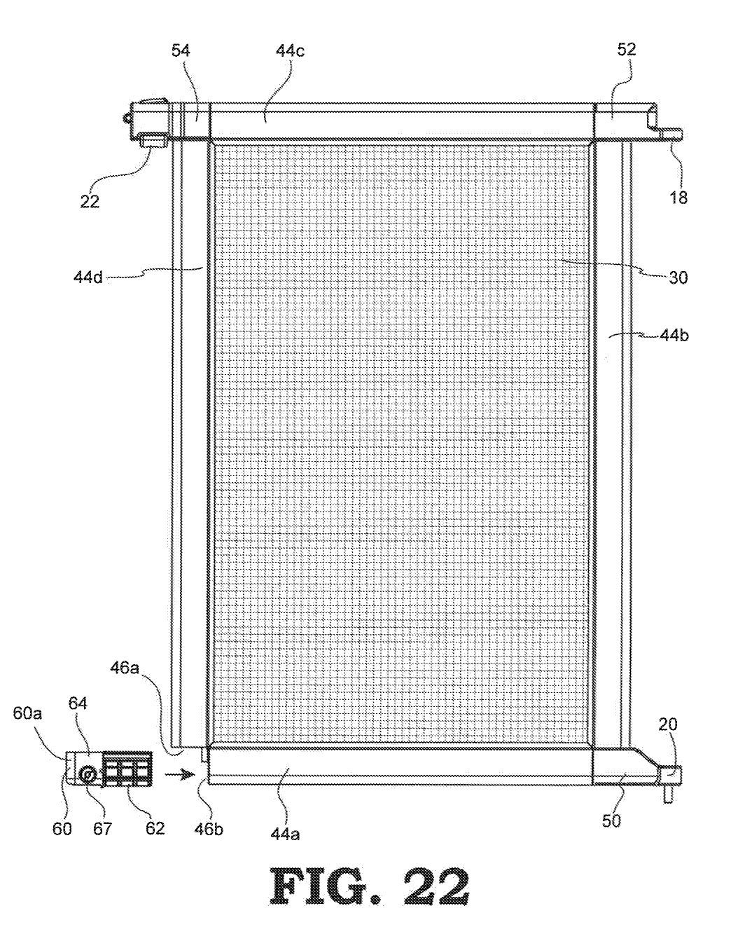

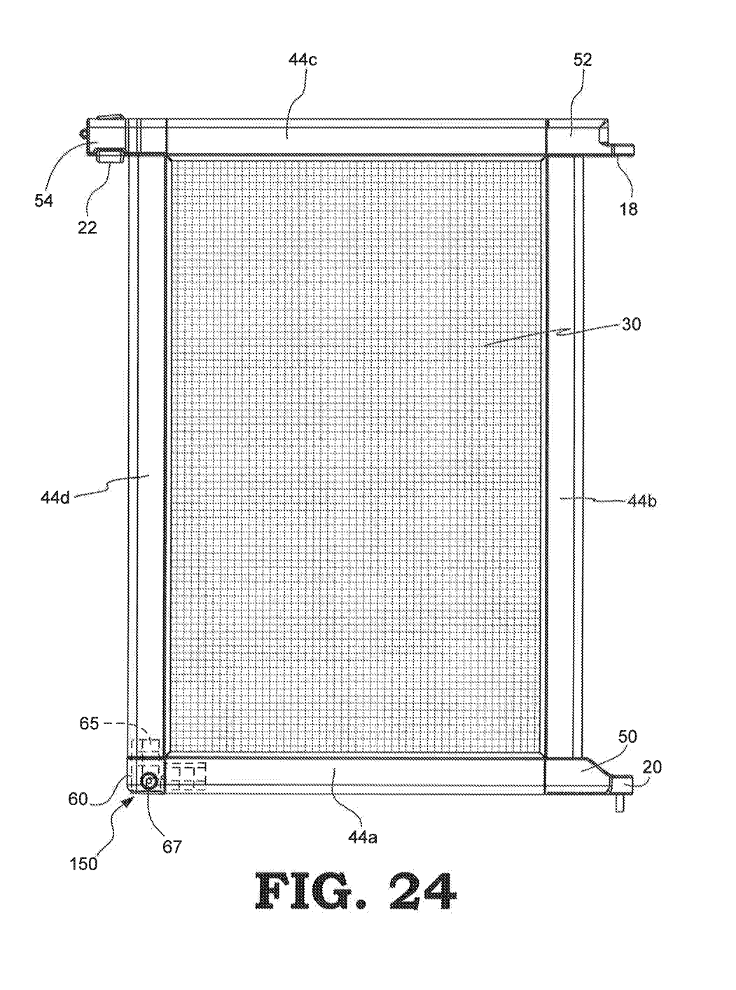

FIGS. 22-25 illustrate a second exemplary embodiment of installing a fourth and final corner 150 member 250 (as shown and assembled in FIG. 24).

FIG. 22 illustrates a second exemplary embodiment of the twelfth step of assembling the barrier 10 by inserting a two-piece fourth corner joint 250. The two-piece fourth corner joint 250 includes a first member 60 and a second member 65. The first member 60 is pressed into the adjacent end 46b of the lower frame member 44a. The first member 60 is secured and received by the lower frame member 44a by a friction fit. The first member 60 also includes a base 60a having an arm or extension 62 extending from the base 60a. An aperture or encircled channel 64 is disposed substantially perpendicular to an axial length of the first member 60 adjacent to the base 60a that the encircled channel 64 is aligned with an opening end 46a of the frame member body 44d. An aperture 66 is provided in the first member 60 to receive a fastener 66. The aperture 66 may also be used to fasten a stopper 70 to the corner joint 250 in assembly such that the fastener 66 is adapted to secure the stopper 70 and the first 60 and second 65 members together by the single fastener 66.

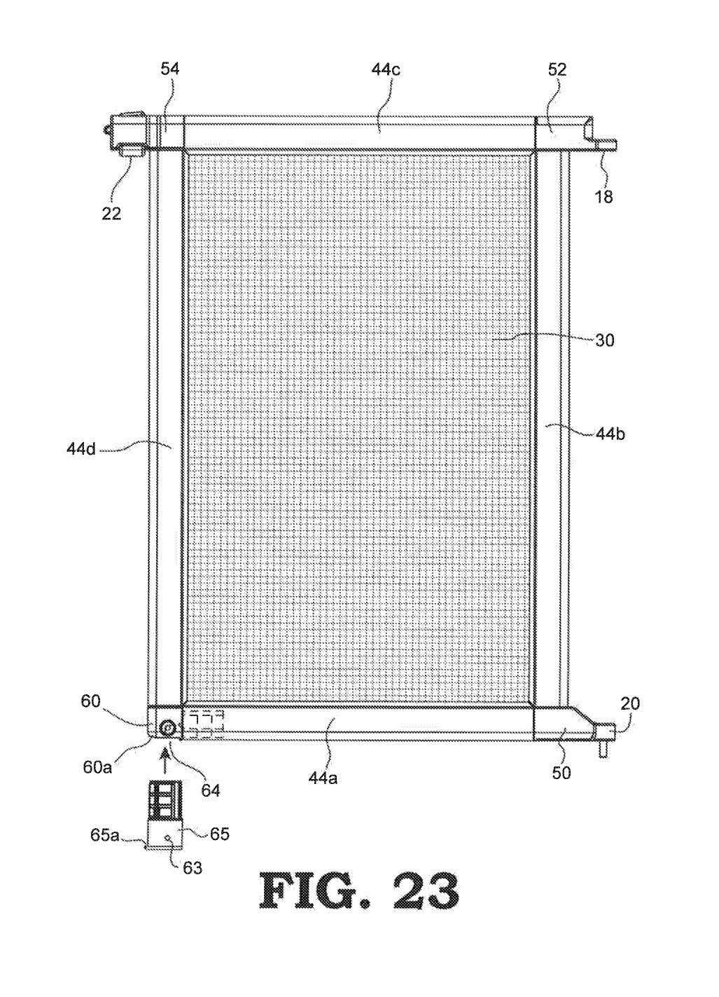

FIG. 23 depicts a thirteenth step of assembling the barrier 10 by inserting the second member 65 through the channel 64 in the first member 60 and into the end 46a of the second side frame member 44d. A lower edge 65a of the second member 65 abuts against a base 60a end of the first member 60 when the second member 65 is fully secured and received by the second side frame member 44d (as shown in FIG. 24). Furthermore, the second member 65 has an aperture 667 which is substantially aligned with the aperture 66 when installed.

FIG. 24 shows a front view of the assembled barrier 10 as constructed after the thirteenth step of FIG. 23. As shown, the second member 65 is shown disposed in the channel 64 substantially in hidden line. The axial length of the extending second member 65 is shown substantially perpendicular to the axial length of the extending first member 60.

FIG. 25 illustrates a perspective view of a second exemplary embodiment of the fourteenth step of assembling the barrier 10 by inserting a fastener 66 into the aperture 67 in the corner stopper 65 and the first members 56/60 and the second members 57/65 of the corner joints 150/250. As shown the fastener 66 may also pass through a rotating stopper 70. The fastener 66 may be a screw, bolt and nut, magnet, clamp, rivet, or any other suitable fastener to secure the first members 56/60 of the two-piece fourth corner joint member to the second members 57/65.

The illustrations and examples provided herein are for explanatory purposes and are not intended to limit the scope of the appended claims. It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

1. A gate, comprising:
an outer casing having a pair of upright frame elements connected to a lower cross element; and
a barrier door positioned within the outer casing and hingedly connected to one of the upright frame elements,
wherein, the barrier door has a frame comprising:
a first side member and a second side member connected at ends by corner joints that are friction fit connected to an upper member and a lower member,
wherein at least one of the corner joints has a first arm friction fit into a first end, and a separate second arm friction fit into an adjacent end, and
wherein simultaneously the first arm is interconnected with the second arm to secure the first arm to the second arm.

2. The gate recited in claim 1, wherein the barrier door has at least another corner joint comprising:
another first arm and another second arm,
wherein the another first arm is friction fit into another first end, and the another second arm is friction fit into another adjacent end.

3. The gate recited in claim 2, wherein the second arm is simultaneous received and secured via a tongue and groove friction fit mating assembly between the first arm and the second arm.

4. The gate recited in claim 2, wherein the second arm is simultaneous received and secured via a projection and channel mating assembly between the first arm and the second arm.

5. The gate recited in claim 2, wherein the first arm, the second arm and a rotating stopper are fixed to each other by a fastener, wherein the rotating stopper can determine the opening and closing direction of the barrier door.

6. The gate recited in claim 2, wherein the another corner joint has a hinge integrated therein.

7. The gate recited in claim 1, wherein the barrier door has a mesh panel secured within the frame of the barrier door.

8. The gate recited in claim 7, wherein the mesh panel has at least one fold formed on at least one edge,
wherein the fold forms an elongated pocket having openings,
wherein a rod is inserted into the pocket through the openings, and
wherein the rod in the pocket is inserted into the frame.

9. A gate, comprising:
an outer casing having a pair of upright frame elements connected to a lower cross element; and
a barrier door having a mesh panel positioned within the outer casing, the barrier door hingedly connected to one of the upright frame elements,
wherein, the barrier door has a frame comprising:
a first side member and a second side member connected at ends by corner joints that are friction fit connected to an upper member and a lower member,
wherein at least one of the corner joints is a two-part corner joint has a first extension that is friction fit into a first end of one of the members, and a second extension friction fit into an adjacent end of another one of the members, and
wherein the first extension has a first friction fit element in a first base that is secured to a second friction fit element on the second extension in a second base.

10. The gate recited in claim 9, wherein the barrier door has another corner joint comprising:
another first arm and another second arm,
wherein the another first arm is friction fit into another first end, and the another second arm is friction fit into another adjacent end.

11. The gate recited in claim 9, wherein the second extension is simultaneous received and secured via a tongue and groove friction fit mating assembly between the first extension and the second extension.

12. The gate recited in claim 9, wherein the second extension is simultaneous received and secured via a projection and channel mating assembly between the first extension and the second extension.

13. The gate recited in claim 9, wherein the first extension and the second extension are locked to each other by a fastener,
wherein the fastener also secures a rotating stopper that can determine the opening and closing direction of the barrier door.

14. The gate recited in claim 9, wherein the mesh panel has at least one fold formed on at least one edge,
wherein the fold forms an elongated pocket having openings,
wherein a rod is inserted into the pocket through the openings, and
wherein the rod in the pocket is inserted into the frame.

15. A mesh gate, comprising:
an outer casing having a pair of upright frame elements connected to a lower cross element; and
a barrier door hingedly connected to one of the upright frame elements of the outer casing, the barrier door comprising:
a frame comprising:
a first side member;
a second side member;
an upper member;
a lower member; and
corner joints,
wherein the first side member and the second side member are friction fit connected at ends by the corner joints to the upper member and the lower member; and
a mesh panel positioned and secured within the frame,
wherein at least one of the corner joints is a separable two-part corner joint that has a first extension arm that is friction fit into a first end of one of the members, and a second extension arm friction fit into an adjacent end of another one of the members, and
wherein the first extension arm has a first friction fit element in a first base that is secured to a second friction fit element disposed in a second base on the second extension arm.

16. The mesh gate recited in claim 15, wherein the barrier door has at least another corner joint comprising:
another first extension arm and another second extension arm,
wherein the another first extension arm is friction fit into another first end, and the another second extension arm is friction fit into another adjacent end.

17. The mesh gate recited in claim 15, wherein the second extension arm is simultaneous received and secured via a tongue and groove friction fit mating assembly between the first extension arm and the second extension arm.

18. The mesh gate recited in claim 15, wherein the second extension arm is simultaneous received and secured via a projection and channel mating assembly between the first extension arm and the second extension arm.

19. The mesh gate recited in claim 15, wherein the first extension arm and the second extension arm are locked to each other by a fastener, wherein the fastener also secures a rotating stopper that can determine the opening and closing direction of the barrier door.

20. The mesh gate recited in claim 15, wherein the mesh panel has at least one fold formed on at least one edge,
wherein the fold forms an elongated pocket having openings,
wherein a rod is inserted into the pocket through the openings, and
wherein the rod in the pocket is inserted into the frame.
